(19) United States
(12) Patent Application Publication
(10) Pub. No.: US 2010/0273532 A1
(43) Pub. Date: Oct. 28, 2010

(54) Mobile Wireless Single Purpose Communication Device

(75) Inventor: Uwe Schmitz, Dusseldorf (DE)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: novero GmbH, Dusseldorf (DE)

(21) Appl. No.: 12/762,939

(22) Filed: Apr. 19, 2010

(30) Foreign Application Priority Data
Apr. 23, 2009 (EP) 09 005 682.1

(51) Int. Cl. H04W 88/02; G06F 3/048

(52) U.S. Cl. 455/566; 715/773; 715/784

(57) ABSTRACT

The present application relates to a mobile wireless Internet communication device with a small, compact, portable housing, an energy supply, a central processing unit comprising at least one processor for operating the device, at least one memory unit in communication with the central processing unit for storing data and operating instructions in a retrievable manner, a transceiver unit for receiving data from other devices and for sending data to other devices, a user interface on the housing and an operating software for operating all components of the device according to the intended purpose. The present application defines a dedicated user-wearable device that is designed as a single purpose micro-blogging device with the hardware and the operating software designed and/or operated to fulfill the major or all functions related to receiving, displaying, storing, retrieving, writing, editing., and sending of text based micro-blogs and the housing is a self-contained, user-wearable unit

### CROSS-REFERENCE TO RELATED APPLICATION

This application claims priority of European Patent Application No. 09 005 682.1, filed Apr. 23, 2009, which application is incorporated herein by reference.

### BACKGROUND

The present application relates to a mobile wireless single purpose communication device.

A mobile wireless single purpose communication device is taught in U.S. Pat. No. 4,894,649 and includes a pager having time controlled user selectable functions. The pager is a. single purpose communication device, because it only receives the pages or messages from different, selectable sources.

Other communication devices in the form of pagers are well known from the prior art, too (U.S. Pat. No. 4,334,694; U.S. Pat. No. 4,385,295),

In the Internet in recent years blogs (a short term for “weblog”) became very popular. A “ blog” is a type of website which is usually maintained by an individual or an institution that behaves like an individual with regular entries describing events, status up-dates, commentaries or other material. For substantial background relating to the term “blog” please refer to the entry at Wikipedia a (en.wikipedia.org).

“weblogs” have developed into a powerful tool for the exchange of information on a personal level with nevertheless substantial general impact on the public.

A special form of “blogging” is “micro-blogging”. This is a blogging that allows users to send brief text messages or micro media such as photos or short clips either to be received by anyone who is interested or by a restricted group of “followers” which can be chosen by the user. A preferred form of communication of a micro-blog is the Internet.

The content of a micro-blog differs from a classic blog in that it is typically more specific and smaller in file size. It is more like a status update in prior forms of communication. Many micro-blogs provide a short commentary on a person-to-person level or share actual news including those about products of companies (corporate blogs).

In the Internet meanwhile blog search engines have been developed, Technorati being one of the most popular search engines thereof. Access to micro-blogging is, however, still restricted due to the possibility to restrict the group of “followers”.

The most popular micro-blogging service is “Twitter” (please note that “Twitter” is a registered trademark of Twitter, Inc., USA). However, more than 100 similar micro-blogging sites internationally were counted in 2007. A micro-blogging service like “Twitter” is a social networking service based on micro-blogging. It enables its users to send and read other users updates. Updates are displayed on the user's profile page and delivered to other users as selected (for further details see the entry “Twitter” at the Wikipedia website).

Micro-blogging like that in the “Twitter” network needs an Internet communication device.

It is known as prior art to have a mobile wireless Internet communication device like an advanced mobile phones (e.g. Apple's iPhone) that allows access to a micro-blogging service like “Twitter” (see e.g. MICHAEL JOHNSTON: “Twitterrific Updated To 1.1, New Features Added, Bugs Squashed” [Online] 5 Sep. 2008 (2008-09-05), IPHONE ALLEY, XP002543625 iPhone Alley Retrieved from the Internet: URL:http://www.iphonealley.com/new/twitterific-updated-to-11-new-features-added-bugs-squashed>[retrieved on 2009-09-01].

There is further ample prior art disclosing multi-purpose devices, in particular mobile phone, that are also mobile wireless Internet communication devices (US-A-2008/168404; BILL STITELER: Appletell reviews Twitterrific for iPhone [Online] 9 Feb. 2009 (2009-02-09). APPLETELL, XP-002543624 Appletell Retrieved from the Internet: URL:http://www/appletell.com/apple/comment/appletell-reviews-twitterrific-for iphone/> [retrieved on 2009-09-01]: WO-A-2006/029331). Such a typical multi-purpose device is mainly a mobile phone or an Internet communication device, but additionally supports a micro-blogging service like “Twitter”,

### SUMMARY

This Internet communication device is presented here as a single purpose portable micro-blogging device, a web-based “pager”.

The device of the present application provides a mobile wireless single purpose communication device, a kind of up-to-date pager, that is specifically designed to support in general an up-to-date mobile social network service.

The mobile wireless single purpose communication device includes a small, compact, portable housing constructed as a self-contained, user wearable unit, an energy supply, preferably in the form of a rechargeable battery, a central processing unit comprising at least one processor for operating the device, at least one memory unit in communication with the central processing unit for storing data and operating instructions in a retrievable manner, a unit for receiving data from other devices over a wireless network, a user interface on the housing, the user interface comprising a display and at least one input key, and an operating software for operating all components of the device according to the intended purpose. The device is designed as a single purpose device with the hardware and the operating software designed and/or operated to fulfill the major or all functions related to receiving, displaying, storing and retrieving of short text-based messages, wherein the unit is designed as a transceiver unit for receiving data from other devices over the wireless network in combination with the Internet, and also for sending data to other devices over the wireless network in combination with the Internet. The transceiver unit comprises a wireless network authorization unit, preferably in the form of a data SIM-card unit. The device is designed for Internet-micro-blogging. only with the hardware and the operating software designed and/or operated to fulfill the major or all functions related to receiving, displaying, storing and retrieving as well as writing, editing, and sending of text-based microblogs. Further preferred improvements and specifics of the communication device are provided.

One embodiment of the present application includes the device designed as a single purpose Internet communication device just for micro-blogging in the respective micro-blogging network like e. g. “Twitter”. in particular the hardware and the operating software is designed and/or operated to fulfill preferably only the major or all functions related to handling text based micro-blogs. However, this communication device is a dedicated wearable device. As in a prior art pager the housing is designed as a self-contained user-wearable unit.

In general it is possible to extend the micro-blogging capability of the communication device beyond text-based micro-blogs to also short clips or photos etc. Nevertheless, the main point is to concentrate the communication device to just the single purpose of micro-blogging in the selected social network.

The present application relates in general to mobile messaging by means of an Internet communication device using the actual generation of the World Wide Web, in short the internet. At present the term “Web 2.0” refers to a kind of second generation of the World Wide Web that facilitates an improved quality of communication including the evolution of Web-based communities, hosted services, social networking sites etc. The term “Web 2.0” is somewhat obscure, because there is no updated technical specification of hardware and software. So it is more the way that software developers and end-users use the Internet that defines the present level of communication as “Web 2.0”.

### BRIEF DESCRIPTION OF THE DRAWINGS

Now, the present application will be described in more detail with reference to the drawings which describe a non limiting embodiment of the invention. In the drawings

FIG. 1 illustrates a functional block diagram illustrating an Internet communication system, according to an embodiment of the present application.

FIG. 2 illustrates a graphical representation of an Internet communication device according to an embodiment of the present application designed as a user wearable unit.

FIG. 3 illustrates a block diagram of the structure of a communication device according to an embodiment of the present application.

In general, for the terms “Web 2.0”, “blog”, “blogging”, “micro-blog”, “micro-blogging”. “social networking service”. “Twitter” reference can be made to the introductory part of the present specification as well as to the website of Wikipedia.

### DETAILED DESCRIPTION OF THE DRAWINGS

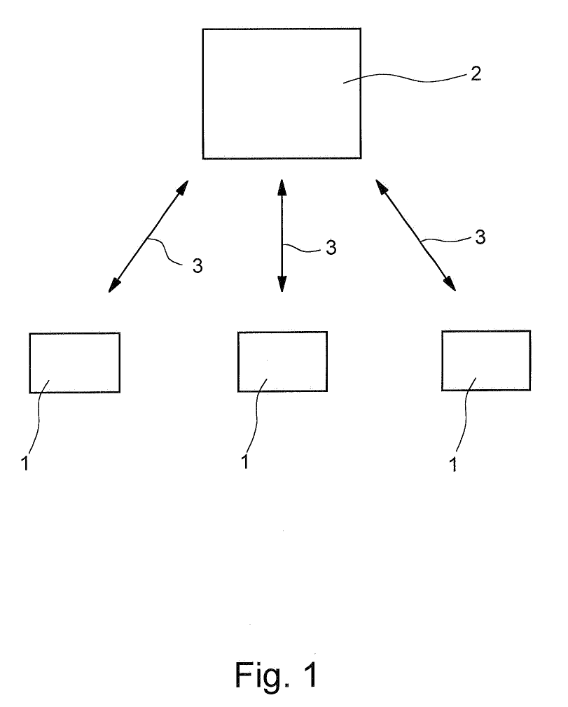

FIG. 1 discloses the general structure of a mobile wireless Internet communication system. There are the front end communication devices 1 which are preferably mobile wireless Internet communication devices but may also be semi-mobile or stationary devices. In general the term “device” in its general meaning may include mobile phones, PDAs, pocket PCs, while stationary devices ma include PCs etc.

The back end is here represented by a server 2, preferably of a social networking service like “Twitter” (Please note that “Twitter” is a registered trademark of Twitter, Inc., USA.).

As shown in FIG. 1 the system includes the mobile wireless network 3 represented by the two-headed arrows 3. The network 3 is in communication with and enables communication between each of the devices 1 and the server 2. In particular the network 3 uses a telecommunications standard like GSM, UMTS or the like for mobile wireless communication.

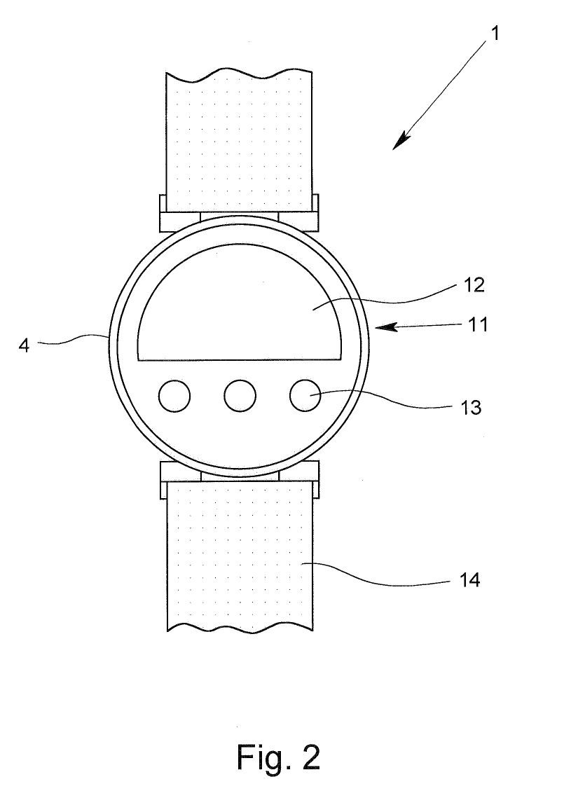

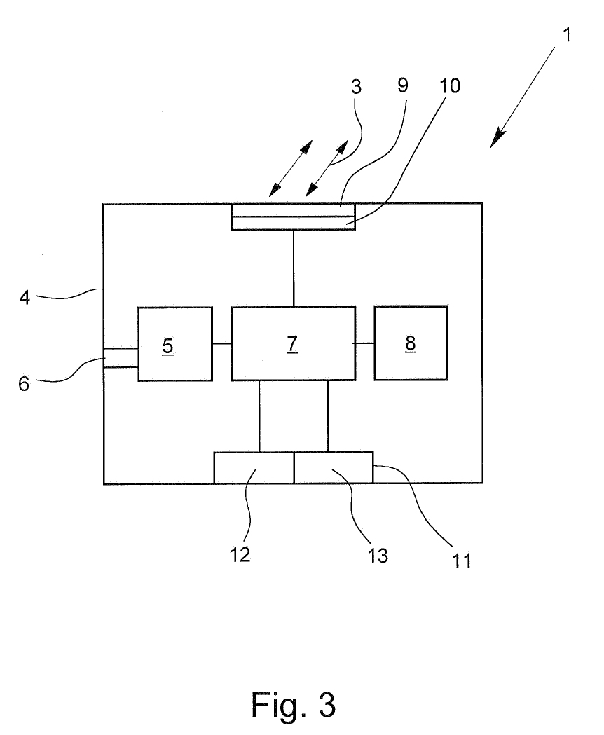

The invention relates to a mobile wireless Internet communication device 1. Such a specific device 1 is disclosed in an embodiment shown in FIG. 2 with its technical lay-out disclosed in FIG. 3 in the form of a block-diagram.

FIGS. 2 and 3 show a small, compact, portable housing 4 of the device 1. FIG. 3 shows in the housing 4 an energy supply 5 which is preferably in the form of a rechargeable battery, its docking socket 6 being indicated as well.

Further, the device 1 comprises in the housing 4 a central processing unit 7 comprising at least one processor for operating the device 1. Associated with the central processing unit 7 is at least one memory unit 8 which can have the design of any generally known memory. The memory unit 8 is in communication with the central processing unit 7 for storing data and operating instructions in a retrievable manner.

A transceiver unit 9 is provided in the housing 4 for receiving data from other devices 1 over the Internet and for sending data to other devices 1 over the Internet. The transceiver unit 9 comprises a wireless network authorization unit 10 which is preferably in the form of a data SIM-card unit. The authorization unit 10, preferably with the SIM-card based on a flat rate payment schedule, allows the device 1 to be constantly online in the network 3.

The device 1 is controlled by means of a user interface 11 comprising a display 12 and at least one input key 13, in the present embodiment in FIG. 2 the display 12 is a simple text display while there are three input keys 13 indicated as push buttons. However, it is preferable that the display 12 is a touch screen display and the input keys 13 are just icons on the touch screen display.

In the memory unit 8 of the device 1 an operating software is stored for operating all components of the device according to the intended purpose.

Now, in the present application, the device 1 is designed as a single purpose micro-blogging device with the hardware 7, 8, 9, 11, and the operating software designed and/or operated to fulfill the major or all functions related to receiving, displaying, storing, retrieving, writing, editing, and sending of text based micro-blogs. As can be seen in FIG. 2 the housing 4 may be a self-contained, user-wearable unit.

As explained above, with a data SIM-card or the like in the authorization unit 10 and by use of a flat rate payment schedule it is possible that the wireless network authorization unit 10 is constantly or almost constantly “on” so that the device 1 is constantly or almost constantly online.

In one embodiment, it is provided that the software is designed to reset the device 1 at intervals that are preset or user-defined. So it is possible to take care of the restricted capacity of the memory unit 8 and to limit the number of micro-blogs that are stored in the memory unit 8.

In a further embodiment it is provided that the display 12 is a scrollable text display of preferably only a small number of, preferably four or five, lines.

As is typical for a micro-blog the software should be designed to restrict the length of a micro-blog to a maximum of 200, preferably of 140 characters, which is the typical maximum length of a text message in the “Twitter” network.

In the present application it is provided that the housing 4 is a self-contained, user-wearable unit. FIG. 2 shows an embodiment thereof as the housing 4 is designed as a wristwatch housing with a strap 14. However, the dedicated user-wearable unit can be designed like a pocket watch, can be designed as a belt-wearable housing, can also be a pendant of some kind, a bracelet, a bracelet pendant, a necklace, a necklace pendant or the like. It can also be the housing 4 in the form of a badge or can be in the form of a pocket diary or a pocket book.

In a further embodiment the device 1 of the invention comprises a low-cost communication transceiver unit 9 with a data SIM-card in the authorization unit 10 featuring a flat rate payment schedule. In one embodiment, the display 12 of the user interface 11 has four to five lines for a scrollable text display. The input keys 13 allow for easy text input either directly or by icons on a touch screen display 12. Energy supply 5 is powerful enough to provide for some follower functions.

As in a stationary or multi-purpose device the mobile wireless Internet communication device 1 may support multiple accounts in a social network service.

The system refreshes at user defined intervals. Reply and direct messages are displayed. The number of still unread micro-blogs is shown. Deleting read or unread micro-blogs is easily done. An alert mode may be selected to show new micro-blogs. Any kind of user profile page may be accessed quickly. A selection between public and group-restricted micro-blogs is easily done. The user interface provides shortcuts for a number of functions. There is even the possibility to have an audio unit added for notification of any kind, in particular incoming new micro-blogs.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent elements with insubstantial differences form the literal languages of the claims.

1. A mobile wireless single purpose communication device comprising:
a housing constructed as a self-contained, user-wearable unit;
an energy supply;
a central processing unit including at least one processor for operating the device;
at least one memory unit in communication with the central processing unit for storing data and operating instructions in a retrievable manner;
a unit for receiving data from other devices over a wireless network;
a user interface on the housing, the user interface including a display and at least one input key; and
an operating software stored in the at least one memory unit, that when executed operates all components of the device according to the intended purpose,
wherein the device is a single purpose device that fulfills at least a set of major functions related to receiving, displaying, storing and retrieving of short text based messages,
wherein the unit is includes a transceiver unit for receiving and sending data from other devices,
the transceiver unit includes a wireless network authorization unit.

2. The communication device according to claim 1, wherein the display is a touch screen and at least one input key is an icon on the touch screen display.

3. The communication device according to claim 2, wherein the user interface comprises no more than four input keys, and the input keys are touch screen icons.

4. The communication device according to claim 1, wherein the length of a micro-blog is a maximum of 200 characters.

5. The communication device according to claim 1, wherein the housing is any one of a wristwatch housing, a belt-wearable housing, a pendant, a bracelet, a bracelet pendant, a necklace, a necklace pendant, a badge, a pocket diary, or a pocket book.

6. The communication device according to claim 1, wherein only the listed functions are fulfilled.

7. The communication device according to claim 1, wherein the wireless network authorization unit is continuously in an on state so that the device is continuously or substantially continuously online.

8. The communication device according to claim 1, wherein the device is reset at intervals that are preset.

9. The communication device according to claim 1, wherein the display, including a maximum of five lines.

10. The communication device according to claim 1, wherein the energy supply is a rechargeable battery.

11. The communication device according to claim 1, wherein the wireless network authorization unit is a data SIM-card unit.

12. The communication device according to claim 1, wherein the length of a micro-blog is a maximum of 140 characters.

13. The communication device according to claim 8, wherein the device is reset at intervals that are user-defined.
